(19) United States
(12) Patent Application Publication
(10) Pub. No.: US 2024/0357434 A1
(43) Pub. Date: Oct. 24, 2024

(54) EFFICIENT HANDOVER FOR POINT-TO-MULTIPOINT COMMUNICATION

(71) Applicant: Nokia Technologies Oy, Espoo (FI)

(72) Inventors: David NAVRÁTIL, Espoo (FI); Philippe GODIN, Massy (FR); Benoist Pierre SEBIRE, Tokyo (JP)

(21) Appl. No.: 18/684,898

(22) PCT Filed: Sep. 8, 2021
(86) PCT No.: PCT/EP2021/074653

§ 371 Date: Feb. 20, 2024

(51) Int. Cl. H04W 36/00; H04W 92/20

(52) U.S. Cl. CPC H04W 36/0007; H04W 36/0058; H04W 36/0069; H04W 92/20

(57) ABSTRACT

Various techniques are provided for an apparatus that can identify a multicast and broadcast services session associated with user equipment device(s) in a serving cell associated with the apparatus, communicate a first information set including information associated with the serving cell and the MBS session provided in the serving cell, receive from an apparatus associated with a neighboring cell, a second information set including information associated with the neighboring cell and an MBS session provided in the neighboring cell, determine at least one MBS serving characteristic associated with the serving cell based on the UEs in the serving cell being served by the apparatus and the received second information set, determine whether the serving cell associated with the apparatus is a preferred cell to serve the MBS session to UEs based on the at least one MBS serving characteristic, and in response to determining that the serving cell associated with the apparatus is the preferred cell to serve the MBS session to UEs, serving, by the apparatus, the MBS session to the UEs communicatively coupled with the apparatus.

### TECHNICAL FIELD

The present specification relates to wireless communications. More specifically to dual connectivity and inter-frequency handover for efficient point to multipoint communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G & 4G wireless networks. 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a device, a system, a non-transitory computer-readable medium (having stored thereon computer executable program code which can be executed on a computer system), and/or a method can perform a process with a method including identifying a multicast and broadcast services (MBS) session associated with one or more user equipment devices (UEs) in a serving cell associated with an apparatus, communicating a first information set including information associated with the serving cell associated with the apparatus and the MBS session provided in the serving cell associated with the apparatus, receiving, at the apparatus from an apparatus associated with a neighboring cell, a second information set including information associated with the neighboring cell and an MBS session provided in the neighboring cell, determining, by the apparatus, at least one MBS serving characteristic associated with the serving cell associated with the apparatus based on the UEs in the serving cell being served by the apparatus and the received second information set, determining, by the apparatus, whether the serving cell associated with the apparatus is a preferred cell to serve the MBS session to UEs based on the at least one MBS serving characteristic, and in response to determining that the serving cell associated with the apparatus is the preferred cell to serve the MBS session to UEs, serving, by the apparatus, the MBS session to the UEs communicatively coupled with the apparatus.

Implementations can include one or more of the following features. For example, the first information set can include, for each neighboring cell providing the MBS session, a number of UEs that can be HO/DC to/with the apparatus associated with the neighboring cell from the serving cell. The second information set can include for each serving cell associated with the apparatus providing the MBS session, a number of UEs that can be HO/DC from/with the apparatus associated with the neighboring cell. The UE that can be HO/DC to/with the apparatus associated with the neighboring cell are the UEs for which the apparatus received, from the UE, a measurement result of the neighboring cell providing the MBS session above a threshold.

The method can further include, in response to determining the apparatus should serve the MBS session to UEs communicatively coupled with the apparatus associated with the neighboring cell, and while the apparatus is serving the MBS session to the UEs that are or were communicatively coupled with the apparatus associated with the neighboring cell, causing, by the apparatus, the MBS session to be served by the apparatus as a PTM transmission. The method can further include, in response to determining the preferred cell to serve the MBS session to UEs is the serving cell associated with the apparatus, communicating, by the apparatus to the apparatus associated with the neighboring cell, an indication of ongoing or possible PTM transmission. The method can further include receiving, at the apparatus from the apparatus associated with the neighboring cell, an indication of ongoing or possible PTM transmission and causing, at the apparatus in response to the reception of the indication, an initialization of a DC/HO for the UEs communicatively coupled with the apparatus. The first information set can further include a number of UEs being served the MBS session per a serving cell of the apparatus and a PTM threshold for the serving cell and the second information set can further include a number of UEs being served the MBS session per a neighboring cell of the apparatus associated with the neighboring cell and a PTM threshold for the neighboring cell.

The method can further include determining, by the apparatus, at least one MBS characteristic associated with the neighboring cell based on the communicated first information set and the received second information set, determining, by the apparatus, which cell of the apparatus or the apparatus associated with the neighboring cell is the preferred cell to serve the MBS session to UEs based on the determined MBS serving characteristics, and one of serving, by the apparatus, the MBS session to the UEs communicatively coupled with the apparatus or causing, by the apparatus, an initialization of a DC/HO for the UEs coupled with the apparatus. The method can further include, if, for the serving cell, the apparatus is serving the MBS session as a point-to-point (PTP) transmission, and the apparatus is serving the MBS session to the UEs that are or were communicatively coupled with the apparatus associated with the neighboring cell, causing, by the apparatus, the MBS session to be served by the apparatus as a PTM transmission in the serving cell.

The method can further include, in response to determining the neighboring cell is the preferred cell to serve the MBS session to UEs communicatively coupled with the apparatus, causing, by the apparatus, the initialization of the DC/HO for the UEs communicatively coupled with the apparatus, the DC/HO being directed to the apparatus associated with the neighboring cell. The at least one MBS serving characteristic can be a UE total calculated as a sum of UEs configured to receive the MBS session and UEs that could be configured to receive that MBS session and the determining of whether a cell can be the preferred cell to serve the MBS session is based on the UE total. The determining of whether a cell is the preferred cell to serve the MBS session to UEs communicatively coupled with the apparatus associated with the neighboring cell can include determining that calculated UE total will meet the PTM threshold. The determining of whether a cell is the preferred cell to serve the MBS session to UEs communicatively coupled with the apparatus associated with the neighboring cell can be based on another criterion if two or more cells be selected based on the at least one MBS serving characteristic. Another criterion can include at least one of a cell identification number, a number of UEs currently being served the MBS session by the apparatus, a number of UEs currently being served the MBS session by the apparatus associated with the neighboring cell, a priority of the apparatus, and a priority of the apparatus associated with the neighboring cell.

The method can further include, if the apparatus determines that the MBS session is to be served by the apparatus associated with the neighboring cell and if the apparatus determines that the UE can be HO/DC to/with the apparatus associated with the neighboring cell, initiating a DC/HO operation directed to the apparatus associated with the neighboring cell in response to a UE being served by the apparatus joining the MBS session. The communicating of the information associated with MBS session can be triggered based on Channel State Information Reference Signal (CSI-RS) measurements, the apparatus switching to PTM, the at least one apparatus associated with the neighboring cell switching to PTM, a number of UEs served by PTP changing by a predetermined number of UEs, and a UE is added to the MBS session via a DC or HO. The information associated with the MBS session can be received using an Xn configuration update message or Xn setup message via an Xn interface. The information associated with the MBS session can include an indication that no UEs can be configured to receive the MBS session from the apparatus. The method can further include triggering a DC/HO operation directed to the least one apparatus associated with the neighboring cell in response to a UE being served by the apparatus joining the MBS session.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a block diagram illustrating a network implementing a multicast MBS session according to an example embodiment.

FIG. 3 is another block diagram illustrating a network implementing a multicast MBS session according to an example embodiment.

FIG. 4 is flow diagram illustrating a handover in a network implementing a multicast MBS session according to an example embodiment.

FIG. 5A is a flow diagram of a network operation for implementing a multicast MBS session according to an example embodiment.

FIG. 5B is another flow diagram of a network operation for implementing a multicast MBS session according to an example embodiment.

FIG. 6 is a block diagram illustrating a method for a handover in a network implementing a multicast MBS session according to an example embodiment.

FIG. 7 is a block diagram illustrating a method for operating a network node according to an example implementation.

FIG. 8 is a block diagram of a wireless station or wireless node (e.g., AP, BS, gNB, RAN node, relay node, UE or user device, network node, network entity, DU, CU-CP, CU-CP, . . . or other node) according to an example embodiment.

### DETAILED DESCRIPTION

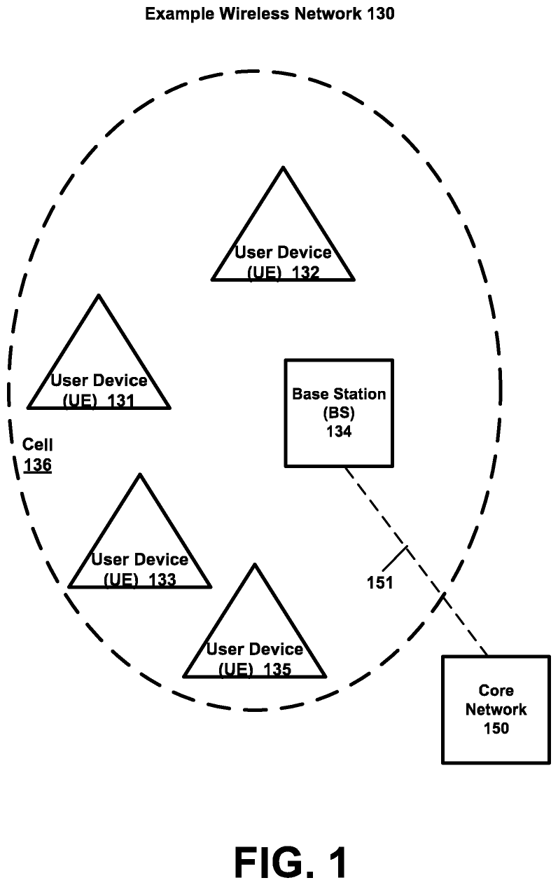

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a BS, next generation Node B (gNB), a next generation enhanced Node B (ng-eNB), or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS). At least part of the functionalities of a BS (e.g., access point (AP), base station (BS) or (e) Node B (eNB), BS, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface or NG interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a centralized unit (CU) and/or a distributed unit (DU) in the case of a split BS or split gNB), or other network node. For example, a BS (or gNB) may include: a distributed unit (DU) network entity, such as a gNB-distributed unit (gNB-DU), and a centralized unit (CU) that may control multiple DUs. In some cases, for example, the centralized unit (CU) may be split or divided into: a control plane entity, such as a gNB-centralized (or central) unit-control plane (gNB-CU-CP), and an user plane entity, such as a gNB-centralized (or central) unit-user plane (gNB-CU-UP). For example, the CU sub-entities (gNB-CU-CP, gNB-CU-UP) may be provided as different logical entities or different software entities (e.g., as separate or distinct software entities, which communicate), which may be running or provided on the same hardware or server, in the cloud, etc., or may be provided on different hardware, systems or servers, e.g., physically separated or running on different systems, hardware or servers.

As noted, in a split configuration of a gNB/BS, the gNB functionality may be split into a DU and a CU. A distributed unit (DU) may provide or establish wireless communications with one or more UEs. Thus, a DUs may provide one or more cells, and may allow UEs to communicate with and/or establish a connection to the DU in order to receive wireless services, such as allowing the UE to send or receive data. A centralized (or central) unit (CU) may provide control functions and/or data-plane functions for one or more connected DUs, e.g., including control functions such as gNB control of transfer of user data, mobility control, radio access network sharing, positioning, session management etc., except those functions allocated exclusively to the DU. CU may control the operation of DUs (e.g., a CU communicates with one or more DUs) over a front-haul (Fs) interface.

According to an illustrative example, in general, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node (e.g., BS, eNB, gNB, CU/DU, . . . ) may forward data to the UE that is received from a network or the core network, and/or forward data received from the UE to the network or core network. RAN nodes (e.g., BS, eNB, gNB, CU/DU, . . . ) may perform a wide variety of other wireless functions or services, e.g., such as broadcasting control information (e.g., such as system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform. A base station may also be DU (Distributed Unit) part of IAB (Integrated Access and Backhaul) node (a.k.a. a relay node). DU facilitates the access link connection(s) for an IAB node.

A user device (user terminal, user equipment (UE), mobile terminal, handheld wireless device, etc.) may refer to a portable computing device that includes wireless mobile communication devices operating either with or without a subscriber identification module (SIM) (which may be referred to as Universal SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. A user device may be also MT (Mobile Termination) part of IAB (Integrated Access and Backhaul) node (a.k.a. a relay node). MT facilitates the backhaul connection for an IAB node.

In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network (e.g., which may be referred to as 5GC in 5G/NR). In addition, by way of illustrative example, the various example embodiments or techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), massive MTC (mMTC), Internet of Things (IoT), and/or narrowband IoT user devices, enhanced mobile broadband (eMBB), and ultra-reliable and low-latency communications (URLLC). Many of these new 5G (NR)-related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The various example embodiments may be applied to a wide variety of wireless technologies or wireless networks, such as LTE, LTE-A, 5G (New Radio (NR)), cmWave, and/or mmWave band networks, IoT, MTC, eMTC, mMTC, eMBB, URLLC, etc., or any other wireless network or wireless technology. These example networks, technologies or data service types are provided only as illustrative examples.

3GPP is introducing support for multicast and broadcast services (MBS). In multicast communication services the UE can join a multicast MBS session of a multicast communication service by sending an explicit request. For example, a protocol data unit (PDU) session modification request can be communicated to a network node (e.g., a BS or a session management function). As such, the network can be fully aware of the UE that joined a multicast MBS session.

In RAN, one of the objective for UEs in RRC_CONNECTED is to support basic mobility with service continuity by means of handover. Further, dual connectivity should be supported for MBS in 5G. For example, NE-DC and NR-DC architecture options should be supported in 5G where at least master node terminating master cell group bearer(s) supports MBS.

The UE can join a multicast MBS session by sending a join message over Non-access stratum (NAS). If the UE is authorized to join the session and if the UE is the first UE joining the session in a cell, then a multicast MBS session is established. The multicast MBS session establishment can include a PDU session modification signaling for updating the UE's context in RAN, establishment of MBS context in RAN, user plane distribution establishment in a core network (CN) (e.g., a shared N3mb tunnel) and RAN configuration of radio bearers for point-to-point (PTP) and/or point-to-multipoint (PTM) transmission over-the-air.

Problems can arise when a 5G system is deployed on multiple frequency layers because radio resources for a multicast MBS session can be established in the cell the UE camps on (e.g., one of possibly several cells covering the location of the UE). Further, multiple UEs may be camping on different cells (e.g., due to dedicated priorities) even though the UEs are in the same location. In the example scenario, the same content (e.g., a mission critical video stream) can be delivered to the UEs in two overlapping cells. Delivering the same content in two overlapping cells may be inefficient considering that all UEs could be served by one cell. The single cell delivery may be an efficient manner using PTM transmission as compared to delivery in multiple cells. A first problem can include, for example, the network nodes (e.g., BSs) do not have any information about what sessions are being served by cells of neighboring network nodes or BS associated with a neighboring cell. A second problem can include, for example, the current measurements and triggering measurement reporting for handover/dual connectivity (DC/HO) decisions may not be sufficient for PTM reception quality estimation.

To overcome these problems, example implementations can include sharing information that can be used to support the DC/HO decisions amongst neighboring network nodes. This information can be used in the determining (e.g., selecting) of a network node to provide the MBS session and then using HO or DC to cause the UEs to receive the MBS session via the selected cell.

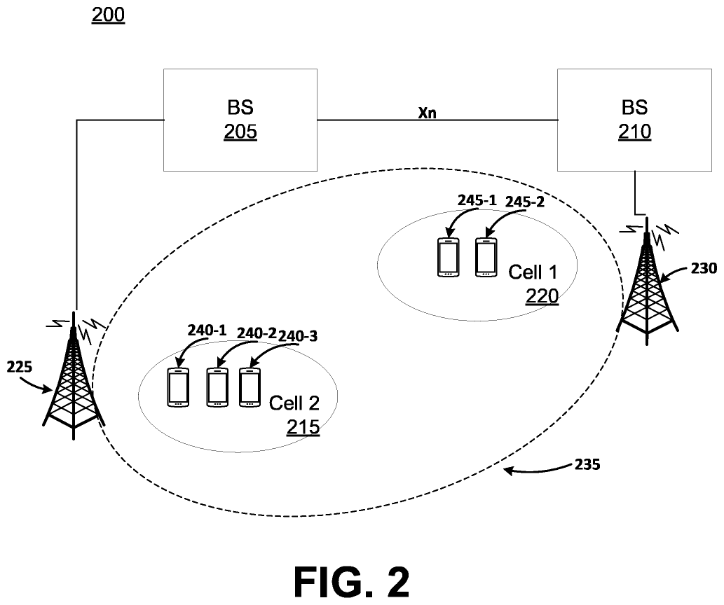

FIG. 2 is a block diagram illustrating a network implementing a multicast MBS session according to an example embodiment. As shown in FIG. 2, a network 200 can include at least two network nodes BS 205 and BS 210. BS 205 can serve a first cell 215 using antenna 225. BS 210 can serve a second cell 220 using antenna 230. The first cell 215 and the second cell 220 can be referred to as frequency layers within a service area 235. The service area 235 can be providing services to a plurality of UEs. For example, the service area 235 can be providing services to UE 240-1, UE 240-2, UE 240-3, UE 245-1, and UE 245-2. The first cell 215 can be communicating with UE 240-1, UE 240-2, and UE 240-3 using a first frequency f1. The second cell 220 can be communicating with UE 245-1 and UE 245-2 using a second frequency f2. The first cell 215 and the second cell 220 are illustrated as being within the bounds (e.g., a geographic bounds) of the service area 235. However, being within the bounds of the service area 235 does not necessarily imply that all UEs within the service area 235 can communicate with all BSs that communicate within the service area 235.

In an example implementation, UE 240-1, UE 240-2, UE 240-3, UE 245-1, and UE 245-2 can be receiving the same MBS session. The MBS session can be PTP and/or PTM. For example, cell 215 can use a PTP MBS session with UE 240-1, UE 240-2, and UE 240-3, and cell 220 can use a PTM MBS session with UE 245-1 and UE 245-2. As mentioned above, serving the same MBS session using more than one cell can be inefficient. Therefore, according to example implementation, a DC/HO operation can be performed with one or more of UE 240-1, UE 240-2, UE 240-3, UE 245-1, and UE 245-2 to cause the MBS session to be served by a single cell.

In some example implementations, a BS can be providing more than one cell each serving the MBS session. Generally, there are two possible example implementations described herein. In the first implementation, the information associated with a cell and the MBS session can be communicated as Xn messages that can be updated with a list of sessions where for each sessions the BS provides a list of serving cells providing the MBS session and for each of these serving cells there can be a threshold for PTM and a list of neighboring cells providing the MBS session. Each item in the list of neighboring cells can include the number of UEs that can be DC/HO to the neighboring cell from the serving cell. Alternatively, this signaling can start with an existing list of serving cells as defined in 3GPP TS 38.423 and includes the MBS session ID, the threshold, and the list of neighboring cells with the numbers. In the second implementation, the information associated with a cell and the MBS session can include the list of neighboring cells and the number of UE(s) that can be DC/HO to a neighboring cell. If the BS does not have information about the neighboring cells serving the MBS session then the BS can indicate MBS session ID and possibly CSI-RS measurement for PTM if the existing CSI-RS for cell mobility is not reused.

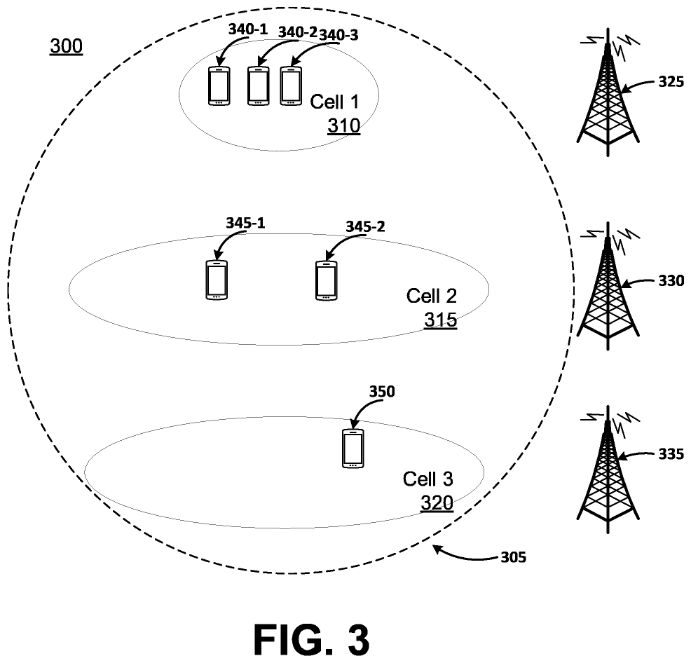

FIG. 3 is another block diagram illustrating a network implementing a multicast MBS session according to an example embodiment. As shown in FIG. 3, a network 300 can include a service area 305. The service area 305 can include a first cell 310, a second cell 315, and a third cell 320. The first cell 310 can be associated with an antenna 325, the second cell 315 can be associated with an antenna 330, and the third cell 320 can be associated with an antenna 335. The service area 305 can be providing services to a plurality of UEs. For example, the service area 305 can be providing services to UE 340-1, UE 340-2, UE 340-3, UE 345-1, UE 345-2, and UE 350. The first cell 310 can be communicating with UE 340-1, UE 340-2, and UE 340-3 using a first frequency f1. The second cell 315 can be communicating with UE 345-1 and UE 345-2 using a second frequency f2. The third cell 320 can be communicating with UE 350 using a third frequency f3.

In an example implementation, UE 240-1, UE 240-2, UE 240-3, UE 245-1, and UE 245-2 can be receiving the same MBS session. The MBS session can be PTP and/or PTM. As mentioned above, serving the same MBS session using more than one cell can be inefficient. Therefore, according to example implementation, a DC/HO operation can be performed. The DC/HO operation can include exchanging information to support a DC/HO decision between BSs. For example, exchanging the information can include communicating (or signaling) messages between BSs using the Xn interface. The messages can include, for example, an identity of the cell and of the MBS session, a number of UEs configured to receive the MBS session from that serving cell, and a number of UEs that could be configured (but are not yet configured) to receive the MBS session from a candidate cell. A candidate cell can be a cell controlled by some other BS for which the UE reported a measurement (CSI-RS, RSRP, etc.) above a threshold.

As an example, a first BS (e.g., a BS associated with the first cell 310 can send/receive the message to/from a second BS (e.g., a BS associated with the second cell 315) and a third BS (e.g., a BS associated with the third cell 320). The second BS can send/receive the message to/from the first BS and the third BS. The third BS can send/receive the message to/from the first BS and the second BS.

Accordingly, the first BS contains (e.g., has stored in memory of the first BS) information including the identity of the second BS and the third BS as well as the MBS session(s) associated with the second cell 315 and the third cell 320. The first BS contains (e.g., has stored in memory of the first BS) information including the number of UEs configured to receive the MBS session that are associated with the second cell 315 (e.g., UE 345-1 and UE 345-2) and the third cell 320 (e.g., UE 350). The first BS contains (e.g., has stored in memory of the first BS) information including the number of UEs that could be configured (but are not yet configured) to receive the MBS session from the second BS and the third BS.

Continuing the example, the second BS contains (e.g., has stored in memory of the second BS) information including the identity of the first BS and the third BS as well as the MBS session(s) associated with the first cell 310 and the third cell 320. The second BS contains (e.g., has stored in memory of the second BS) information including the number of UEs configured to receive the MBS session that are associated with the first cell 310 (e.g., UE 340-1, 340-2, and UE 340-3) and the third cell 320 (e.g., UE 350). The second BS contains (e.g., has stored in memory of the second BS) information including the number of UEs that could be configured (but are not yet configured) to receive the MBS session from the first BS and the third BS.

Further, the third BS contains (e.g., has stored in memory of the third BS) information including the identity of the first BS and the second BS as well as the MBS session(s) associated with the first cell 310 and the second cell 315. The third BS contains (e.g., has stored in memory of the third BS) information including the number of UEs configured to receive the MBS session that associated with the first cell 310 (e.g., UE 340-1, 340-2, and UE 340-3) and the second cell 315 (e.g., UE 345-1 and 345-2). The third BS contains (e.g., has stored in memory of the third BS) information including the number of UEs that could be configured (but are not yet configured) to receive the MBS session from the first BS and the second BS.

After the exchange of information, the first BS, the second BS, and the third BS can determine if the BS should serve via one of its cells the MBS session for a UE which can be later achieved by either adding the corresponding cell of the BS to the UE's configuration (including DC) or transferring (including HO) the UE to the BS. Whether to perform DC or HO is subject to the serving BS decision. For example, the information can include a number of UEs configured to receive the MBS session by the at least one second BS in a second cell, and a number of UEs that could be configured to receive the MBS session in a first cell of the first BS. Each BS can calculate a sum of UEs configured to receive the MBS session and UEs that could be configured to receive that MBS session for the cell and for the neighbouring cells. The information can include an identification of a cell, a BS, and/or a UE.

In an example implementation, the UEs included in the information (and the calculations) can be UEs that have measured the neighbor cell with a high enough quality to receive the MBS session (e.g., as SpCell or SCell). The UEs that are in an idle or inactive state can be excluded from the information (and the calculations). In an example implementation the cell with the highest calculated sum can be selected as the best cell for providing the MBS session by all cells in all BSs. Should there be two cells that can serve the same amount of UEs then the selected cell can be based on another criterion. For example, another criterion can be which cell is currently serving more UEs, which cell has a lower cell ID, which cell has a higher priority based on, for example, configured through operation, administration and maintenance (OAM) or cell selection priorities. The BS that is hosting UEs that can be configured to receive the MBS session from the selected cell can then initiate DC or HO towards the BS operating the selected cell. The selected BS can serve or be configured (e.g., switched from PTP) to serve the MBS session as a PTM transmission in the cell declared as the preferred cell.

In one scenario, PTM may not be used in the selected cell even when all UEs from BSs associated with neighboring cells are configured with DC or HO to the selected cell because, for example, the threshold for switching to PTM transmission may not be met in the selected cell (even with the additional UEs). Therefore, to avoid this scenario, the exchanged information can include a threshold (e.g., a minimum number of UEs receiving the MBS session for switching to PTM) indicating to specific BSs the minimum number of additional of UEs to be configured to receive an MBS session. If the threshold is not met, the DC/HO operation may not be triggered.

In an example implementation, when assessing the number of UEs configured to receive the MBS session from a serving BS, if a cell of the serving BS is known to be overloaded, the exchanged information can include an indication that no additional UEs can be configured to receive the MBS session. In other words, only a subset of the UEs may be transferred to a selected BS. For example, a predetermined value (e.g., non-zero number) could indicate that no additional UEs should be configured to receive the MBS session from that serving BS (e.g., as SpCell or SCell). Since serving a UE as SpCell can consume more resources than the BS associated with SCell, two codepoints could be used to distinguish whether the serving BS could be considered as SCell or SpCell. Continuing the Example above, UEs 340-1, 340-2 and 340-3 may be transferred to the second BS (for cell 315) and UE 350 may remain in the third cell 320. In this situation, the second BS may only have the capacity to add three additional UE's and/or the UE 350 may not be configured and/or have the capability of being served by the second BS.

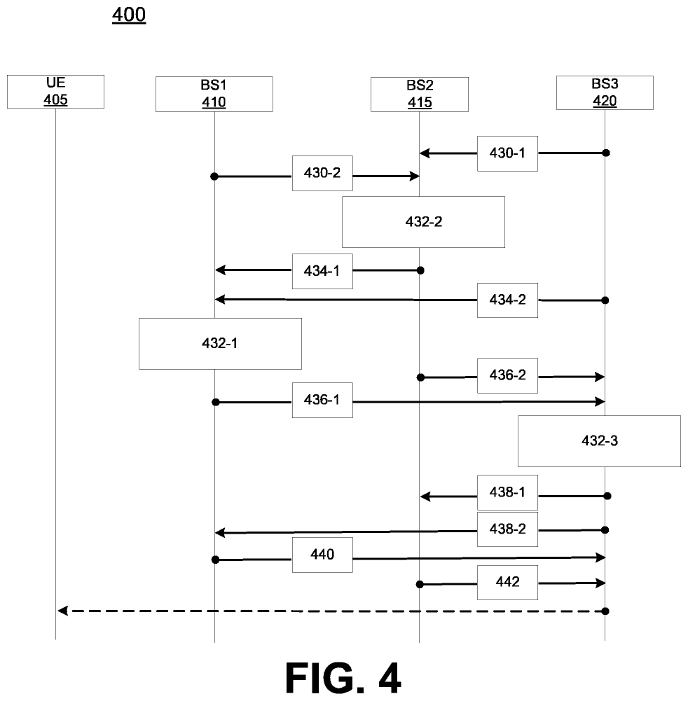

FIG. 4 can be used to describe a possible use case of the DC/HO operation of a UE being served an MBS session. In an example implementation, using communicated information associated with the MBS session, each BS can determine at least one MBS serving characteristic associated with the BS based on the BS's knowledge about the number of UEs being served the MBS session and the information communicated from the BSs associated with neighboring cells. Then, the BS determines whether the BS should serve the MBS session to UEs communicatively coupled with the BS (e.g., in a cell associated with the BS) based on the at least one MBS serving characteristic. In an example implementation, the MBS serving characteristic can be based on information associated with a cell serving the MBS session. The information can include an MBS session ID, a threshold value associated with a number of UEs that will cause BS1 410 to serve the MBS session as PTM, a number of UEs BS1 405 is serving the MBS session to, CSI-RS-CellMobility for PTM, and a list of neighbouring cells providing the MBS session where the list includes for each neighbouring cell a number of UEs that can HO/DC (note, not all UEs may be able to HO/DC). In addition, BS1 can inform other (e.g., associated with neighboring cells) BSs that BS1 is available (e.g., has capacity, is in PTM, and/or can switch to PTM) to serve the MBS session to additional UEs.

In an example implementation, a BS (e.g., gNB) determines that one or several UEs receiving an MBS session in a cell of the BS via PTP (could be extended to PTM for offloading) could also be served advantageously by a BS associated with neighboring cells. The determination can be based on, for example, if CSI-RS measurement is above the CSI-RS measurement threshold receive over Xn or above an implementation specific threshold. The BS can communicate (e.g., send) a Xn configuration Update to the BS associated with the neighboring cell to inform of number of UEs that could be (e.g., have the potential to) configured with DC with a cell of the BS associated with the neighboring cell or handed over to the BS associated with the neighboring cell based on, for example, a CSI-RS measurement (whether to perform a handover or reconfigure a UE with DC is the decision of the BS). If the BS associated with the neighboring cell is delivering the MBS session over PTM the BS associated with the neighboring cell can reply with an Xn configuration update acknowledge informing that PTM is used for the session. The BS can trigger DC/HO of the UEs to the BS associated with the neighboring cell. Other BSs associated with neighboring cells serving the MBS session can go through the same process.

The BS can refrain from the DC/HO operation, unless caused by poor channel quality, if the BS is in PTP and the sum of the number of UEs being served the MBS session and the number of UEs that could be transferred to the BS from the BSs associated with neighboring cells is above a threshold causing the BS to trigger a switch to PTM. The threshold number of UEs can be a minimum number of UEs that will trigger a switch to PTM.

FIG. 4 is a flow diagram illustrating an exchange of MBS information in a network implementing a multicast MBS session to assist BSs in the DC/HO decision for the purpose of optimal delivery using PTM according to an example embodiment. As shown in FIG. 4, an MBS session can be being served by multiple (e.g., neighboring) BSs shown as a system 400 including BS1 410, BS2 415, and BS3 420. The system 400 can also include a plurality UE's, shown as UE 405 being served the MBS session. For example, BS1 410 can be serving the MBS session to UE 405.

As shown in FIG. 4, BS1 410 can communicate a message including information associated with the MBS session as served by BS1 410 to BS2 415 (block 430-1) and BS3 420 can communicate a message including information associated with the MBS session as served by BS3 420 to BS2 415 (block 430-2). The messages including information associated with the MBS session can include, for each cell serving the MBS session of the BS, a number of UEs that can be DC/HO to/with the BS (i.e. the cell is a candidate cell for serving the MBS session to the UE under the BS). It should be understood without any limitation that BS also refers to one or more cells being control by BS in the following description. After receiving the message including information associated with the MBS session, BS2 415 can determine (block 432-2) whether or not UEs receiving the MBS session from BS1 410 and/or BS3 420 should be served by BS2 415. For example, the determination can be a calculated comparison. The BS2 415 can have N UEs in PTP, BS1 410 can have N1 UEs that can be DC/HO to/with BS2 415, and BS3 420 can have N3 UEs that can be DC/HO to/with BS2 415. The calculated comparison N+N1+N3>T (where T is the BS2 415 threshold for PTM). In the example described with regard to FIG. 4, for BS2 415 N+N1+N3<T. Therefore, this process can be repeated at one of the other BSs (associated with neighboring cells). There may or may not be a time delay before continuing the process.

Next, BS2 415 can communicate a message including information associated with the MBS session as served by BS2 415 to BS1 410 (block 434-1) and BS3 420 can communicate a message including information associated with the MBS session as served by BS3 420 to BS1 410 (block 434-2). After receiving the message including information associated with the MBS session, BS1 410 can determine (block 432-1) whether or not UEs receiving the MBS session from BS2 415 and/or BS3 420 should be served by BS1 410. For example, the determination can be a calculated comparison. The BS1 410 can have N UEs in PTP, BS2 415 can have N2 UEs that can be DC/HO to/with BS1 410, and BS3 420 can have N3 UEs that can be DC/HO to/with BS1 410. The calculated comparison N+N2+N3>T (where T is the BS1 410 threshold for PTM). In the example described with regard to FIG. 4, for BS1 415 N+N2+N3<T. Therefore, this process can be repeated at one of the other BSs (associated with neighboring cells). There may or may not be a time delay before continuing the process.

Next, BS1 410 can communicate a message including information associated with the MBS session as served by BS1 410 to BS3 420 (block 436-1) and BS2 415 can communicate a message including information associated with the MBS session as served by BS2 415 to BS3 420 (block 436-2). After receiving the message including information associated with the MBS session, BS3 420 can determine (block 432-3) whether or not UEs receiving the MBS session from BS1 410 and/or BS2 415 should be served by BS3 420. For example, the determination can be a calculated comparison. The BS3 420 can have N UEs in PTP, BS1 410 can have N1 UEs that can be DC/HO to/with BS3 420, and BS2 415 can have N2 UEs that can be DC/HO to/with BS3 420. The calculated comparison N+N1+N2>T (where T is the BS3 420 threshold for PTM).

In the example described with regard to FIG. 4, for BS3 420 N+N1+N2>T. Therefore, BS3 can communicate a message including a request or an indication of possible PTM to the BS1 410 (block 438-2) and/or BS2 415 (block 438-1) to cause a DC/HO operation for associated UEs receiving the MBS session. The message including the request can be an Xn configuration update response that indicates BS3 420 can possibly switch to PTM. Then, BS1 410 and/or BS2 415 can trigger a DC/HO. After the DC/HO is triggered, BS1 410 can communicate a message (block 440) to BS3 420 and BS2 415 can communicate a message (block 442) to BS3 420. The communicated messages can be SN addition request messages or Handover request message.

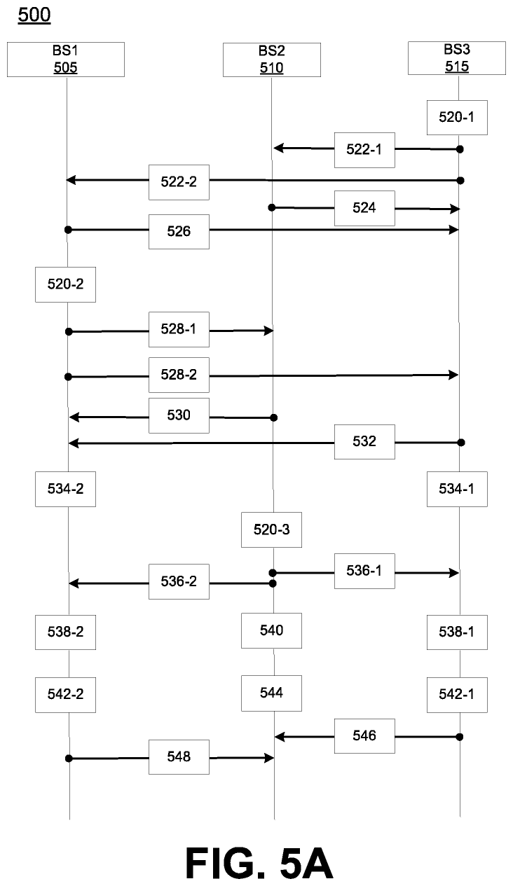

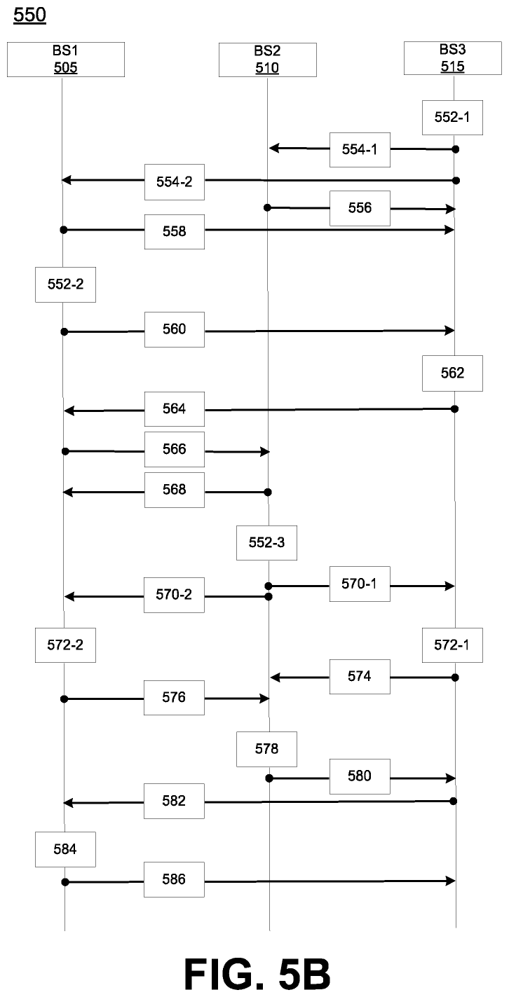

FIGS. 5A and 5B can be used to describe two (of many) possible use cases of a network operation for implementing a multicast MBS session according to an example embodiment. FIG. 5A is a flow diagram illustrating operation of a network implementing a multicast MBS session according to an example embodiment. As shown in FIG. 5A, an MBS session can be being served by multiple (e.g., neighbouring) network nodes shown as a system 500 including BS1 505, BS2 510, and BS3 515. The system 500 can be configured to serve a plurality UE's (not shown) being served the MBS session.

Blocks 520-1, 520-2, and 520-3 are operations including UE(s) joining (or joined) the MBS session. Initially, block 520-1 indicates UE(s) joined an MBS session in a cell associated with BS3 515. Referring to FIG. 3, the cell associated with BS3 515 can be the third cell 320. In blocks 522-1 and 522-2, a message is communicated to BS1 505 and BS2 510 from BS3 515. These messages can include information associated with the MBS session as relates to the cell associated with BS3 515 (e.g., the third cell 320). The message can be an Xn Configuration update request message. The information (as relates to the cell associated with BS3 515 (e.g., the third cell 320)) can include an MBS session ID, a threshold value associated with a number of UEs that will cause BS3 515 to serve the MBS session as PTM, a number of UEs BS3 515 is serving the MBS session to in the cell, and CSI-RS-CellMobility for PTM. Referring to FIG. 3, the third cell 320 includes one UE. Therefore, the number of UEs BS3 515 is serving the MBS session to can be equal to one (1). Assuming the MBS session ID is 1 and the threshold value is 6, blocks 522-1 and 522-2 can include an Xn Configuration update request message with the data fields 1, 6, 1.

In blocks 524 and 526, a message is communicated from BS1 505 and BS2 510 to BS3 515. The messages can be Xn Configuration update response messages from the corresponding BS. Block 520-2 indicates UE(s) joined the MBS session in a cell associated with BS1 505. Referring to FIG. 3, the cell associated with BS1 505 can be the first cell 310. In blocks 528-1 and 528-2, a message is communicated to BS2 510 and BS3 515 from BS1 505. These messages can include information associated with the MBS session as relates to the cell associated with BS1 505 (e.g., the first cell 310). The message can be an Xn Configuration update request message. The information (as relates to the cell associated with BS1 505 (e.g., the first cell 310)) can include an MBS session ID, a threshold value associated with a number of UEs that will cause BS1 505 to serve the MBS session as PTM, a number of UEs BS1 505 is serving the MBS session to, CSI-RS-CellMobility for PTM, and a list of neighbouring cells providing the MBS session where the list includes for each neighbouring cell a number of UEs that can HO/DC (note, not all UEs may be able to HO/DC). Referring to FIG. 3, the first cell 310 includes three UEs. Therefore, the number of UEs BS1 505 is serving the MBS session to can be equal to three (3). In addition, BS1 identifies there are three (3) UEs that can be HO/DC to the third cell 320 and thus the list of the neighbouring cells includes the number of UEs equal to three (3) for the third cell. Again, assuming the MBS session ID is 1 and the threshold value for the first cell 310 is 5, blocks 528-1 and 528-2 can include an Xn Configuration update request message with the data fields 1, 5, 3, third cell 320=3.

In blocks 530 and 532, a message is communicated from BS3 515 and BS2 510 to BS1 505. The messages can be Xn Configuration update response messages from the corresponding BS. In blocks 534-1 and 534-2 the respective BS determines MBS serving characteristics based on the (four) Xn Configuration update request messages. In this example, there are no cells that are above the threshold. Block 520-3 indicates UE(s) joined the MBS session in a cell associated with BS2 510. Referring to FIG. 3, the cell associated with BS2 510 can be the second cell 315. In blocks 536-1 and 536-2, a message is communicated to BS1 505 and BS3 515 from BS2 510. These messages can include information associated with the MBS session as relates to the cell associated with BS2 510 (e.g., the second cell 315). The message can be an Xn Configuration update request message. The information (as relates to the cell associated with BS2 510 (e.g., the second cell 315)) can include an MBS session ID, a threshold value associated with a number of UEs that will cause BS2 515 to serve the MBS session as PTM, a number of UEs BS2 510 is serving the MBS session to, CSI-RS-CellMobility for PTM, and a list of neighbouring cells providing the MBS session where the list includes for each neighbouring cell a number of UEs that can HO/DC (note, not all UEs may be able to HO/DC). Referring to FIG. 3, the second cell 315 includes two UEs. Therefore, the number of UEs BS2 510 is serving the MBS session to can be equal to two (2). In addition, BS2 510 identifies there is one (1) UE that can be HO/DC to the first cell 310 and there are two (2) UEs that can be HO/DC to the third cell 320. The list of the neighbouring cells includes the number of UEs equal to one (1) for the first cell 310 and the number of UEs equal to two (2) for the third cell 320. Again, assuming the MBS session ID is 1 and the threshold value is 5, blocks 536-1 and 536-2 can include an Xn Configuration update request message with the data fields 1, 5, 2, first cell 310=1, third cell 320=2.

At this point in the signal flow, all of the neighbours have communicated with each other. In blocks 538-1 and 538-2, the respective BS determines MBS serving characteristics with the addition of the information associated with the cell associated with BS2 510 (e.g., the second cell 315). In this example, adding the UEs to BS2 510 (e.g., the second cell 315) will cause PTM transmission (one UE above the threshold). Therefore, the cell associated with BS2 510 (e.g., the second cell 315) is selected as the candidate cell for the MBS session. In block 540 BS2 510 (e.g., the second cell 315) determines MBS serving characteristics. In blocks 542-1 and 542-2, the respective BS initiates HO/DC towards BS2 510 (e.g., the second cell 315). In block 544 BS2 510 (e.g., the second cell 315) continues serving UE(s). Should the UEs HO/DC to BS2 510 (e.g., the second cell 315), BS2 510 should serve the MBS session using PTM. In blocks 546 and 548, a message is communicated from BS1 505 and BS3 515 to BS2 510. These messages can be an SN addition request message and/or handover request.

FIG. 5B is another flow diagram illustrating operation of a network implementing a multicast MBS session according to an example embodiment. As shown in FIG. 5B, an MBS session can be being served by multiple (e.g., neighbouring) network nodes shown as a system 550 including BS1 505, BS2 510, and BS3 515. The system 550 can be configured to serve a plurality UE's (not shown) being served the MBS session.

Blocks 552-1, 552-2, and 552-3 are operations including UE(s) joining (or joined) the MBS session. Initially, block 552-1 indicates UE(s) joined an MBS session in a cell associated with BS3 515. Referring to FIG. 3, the cell associated with BS3 515 can be the third cell 320. In blocks 554-1 and 554-2, a message is communicated to BS1 505 and BS2 510 from BS3 515. These messages can include information associated with the MBS session as relates to the cell associated with BS3 515 (e.g., the third cell 320). The message can be an Xn Configuration update request message. The information (as relates to the cell associated with BS3 515 (e.g., the third cell 320)) can include an MBS session ID and CSI-RS-CellMobility for PTM. Referring to FIG. 3, the third cell 320 includes one UE. Therefore, the number of UEs BS3 515 is serving the MBS session to can be equal to one (1). Assuming the MBS session ID is 1, blocks 554-1 and 554-2 can include an Xn Configuration update request message with the data fields 1, CSI-RS-CellMobility for PTM for the third cell 320.

In blocks 556 and 558, a message is communicated from BS1 505 and BS2 510 to BS3 515. The messages can be Xn Configuration update response messages from the corresponding BS. Block 552-2 indicates UE(s) joined the MBS session in a cell associated with BS1 505. Referring to FIG. 3, the cell associated with BS1 505 can be the first cell 310. In block 560, a message is communicated to BS3 515 from BS1 505. The message can include information associated with the MBS session as relates to the cell associated with BS1 505 (e.g., the first cell 310). The message can be an Xn update request message. The information (as relates to the cell associated with BS1 505 (e.g., the first cell 310)) can include an MBS session ID and CSI-RS-CellMobility for PTM. Referring to FIG. 3, the first cell 310 includes three UEs. Therefore, the number of UEs BS1 505 is serving the MBS session to can be equal to three (3). In addition, BS1 505 identifies there are three (3) UEs that can be HO/DC to the third cell 320. Again, assuming the MBS session ID is 1, block 560 can include an Xn update request message with the data fields 1 for the first cell 310, 3 for the third cell 320 (i.e., can HO/DC 3 UEs to the third cell 320).

In block 562 BS3 515 determines MBS serving characteristics based on the Xn Configuration update request messages. In this example, there are no cells that are above the threshold. In block 564, a message is communicated from BS3 515 to BS1 505. The message can be a Xn Configuration update response message. The message can be configured to indicate (implicitly or explicitly) that BS3 515 does not want to serve with PTM. In block 566, a message is communicated from BS1 505 to BS2 510. The message can include information associated with the MBS session as relates to the cell associated with BS1 505 (e.g., the first cell 310). The message can be an Xn Configuration update request message. The information (as relates to the cell associated with BS1 505 (e.g., the first cell 310)) can include an MBS session ID and CSI-RS-CellMobility for PTM. Referring to FIG. 3, the first cell 310 includes three UEs. Therefore, the number of UEs BS1 505 is serving the MBS session to can be equal to three (3). Assuming the MBS session ID is 1, block 566 can include an Xn Configuration update request message with the data fields 1, CSI-RS-CellMobility for PTM for the first cell 310. In block 568, a message is communicated from BS2 510 to BS1 505. The messages can be a Xn Configuration update response message.

Block 552-3 indicates UE(s) joined the MBS session in a cell associated with BS2 510. Referring to FIG. 3, the cell associated with BS2 510 can be the second cell 315. In blocks 570-1 and 570-2, a message is communicated to BS1 505 and BS3 515 from BS2 510. These messages can include information associated with the MBS session as relates to the cell associated with BS2 510 (e.g., the second cell 315). The message can be an Xn update request message. The information (as relates to the cell associated with BS2 510 (e.g., the second cell 315)) can include an MBS session ID and CSI-RS-CellMobility for PTM. Referring to FIG. 3, the second cell 315 includes two UEs. Therefore, the number of UEs BS2 510 is serving the MBS session to can be equal to two (2). In addition, BS2 identifies there is one (1) UE that can be HO/DC to the first cell 310 and there are two (2) UEs that can be HO/DC to the third cell 320, Again, assuming the MBS session ID is 1, block 570-1 can include an Xn update request message with the data fields 1 for the second cell 315, 2 for the third cell 320 (i.e., can HO/DC 2 UEs to BS3 515 (e.g., the third cell 320)) and block 570-2 can include an Xn update request message with the data fields 1 for the second cell 315, 1 for the first cell 310 (i.e., can HO/DC 1 UE to BS1 505 (e.g., the first cell 310)).

In blocks 572-1 and 572-2, a calculation related to PTM is performed. In block 572-1, the calculation is whether or not BS1 505 (e.g., the first cell 310) can switch to PTM. The calculation can use and/or be based on the MBS serving characteristic(s) described above. In block 572-1, the calculation is 3+1<5 (indicating no PTM). In block 572-2, the calculation is whether or not BS3 515 (e.g., the third cell 320) can switch to PTM. In block 572-2, the calculation is 3+2+1=>6 (indicating PTM). In block 574, a message is communicated from BS3 515 to BS2 510. The message can be a Xn Configuration update response message. The message can be configured to indicate that BS3 515 does want to serve with PTM. In block 576, a message is communicated from BS1 505 to BS2 510. The message can be a Xn Configuration update response message. The message can be configured to indicate that BS1 505 does not want to serve with PTM.

In block 578 BS2 510 initiates a DC/HO towards BS3 515. In block 580, a message is communicated from BS2 510 to BS3 515. The message can be a SN addition request and/or handover request. In block 582, a message is communicated to BS1 505 from BS3 515. The message can include information associated with the MBS session as relates to the cell associated with BS3 515 (e.g., the third cell 320). The message can be an Xn Configuration update request message. The information (as relates to the cell associated with BS3 515 (e.g., the third cell 320)) can include an MBS session ID, an indication of possible or ongoing PTM for the MBS session, and CSI-RS-CellMobility for PTM. In block 584 BS1 505 initiates a DC/HO towards BS3 515. In block 586, a message is communicated from BS1 505 to BS3 515. The message can be a SN addition request and/or handover request.

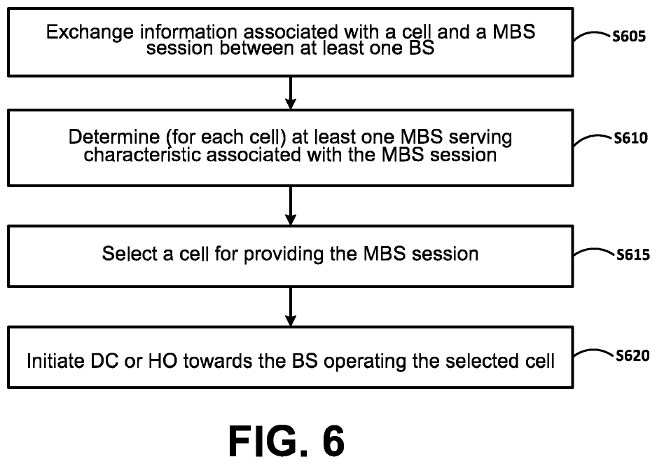

FIG. 6 is a block diagram illustrating a method for an exchange of MBS session information to assist BSs in the DC/HO decision for UEs being served the multicast MBS session in a network implementing a multicast MBS session according to an example embodiment. As shown in FIG. 6, in step S605 information associated with a cell and an MBS session is exchanged between at least one BS. For example, a plurality of neighbouring cells (e.g., three cells as shown in FIG. 3) be serving an MBS session to at least one UE. The BS associated with each of the neighbouring cells can exchange information about the MBS session as applies to the respective cell. The information (e.g., the information associated with the MBS session) can include at least one of a number of UEs per serving cell, a point-to-multipoint (PTM) threshold per serving cell, and, for each neighbouring cell providing the MBS session, a number of UEs that can be HO/DC to/with at least one neighbouring BS from the serving cell.

In step S610 at least one MBS serving characteristic associated with the MBS session is determined (for each cell). For example, the BS associated with each cell can determine at least one MBS serving characteristic based on the information associated with the MBS session. Each BS can determine its own MBS serving characteristic(s) as well as the MBS serving characteristic(s) associated with the neighbouring cells. The at least one MBS serving characteristic can be, for example, a UE total calculated as a sum of UEs configured to receive the MBS session and UEs that could be configured to receive that MBS session

In step S615 a cell for providing the MBS session is selected. For example, the cell that is most likely to switch to (or already serving with) PTM for serving the MBS session. In an example implementation, each cell can have an associated number of UEs that should the cell exceed serving the threshold number of UEs, the cell will switch to PTM for serving the MBS session.

In step S620 DC or HO towards the BS operating the selected cell is initiated. The BS currently serving the MBS session to the UEs in a cell excluding the selected cell can initiate DC or HO towards the BS controlling the selected cell.

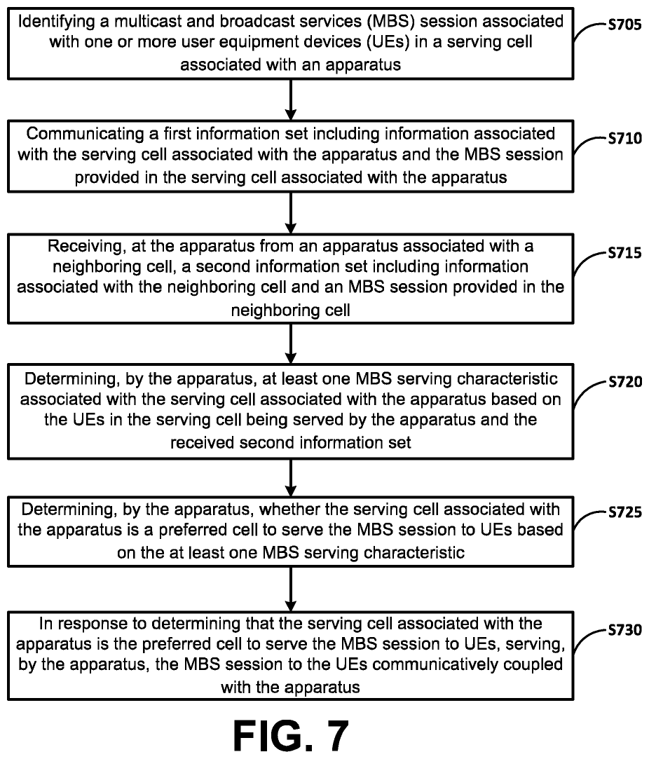

Example 1. FIG. 7 is a block diagram of a method of operating an apparatus (e.g., a computing device, a node, a network node, a base station (BS), an eNB, and/or the like). The method including, in step S705, identifying a multicast and broadcast services (MBS) session associated with one or more user equipment devices (UEs) in a serving cell associated with an apparatus. In step S710 communicating a first information set including information associated with the serving cell associated with the apparatus and the MBS session provided in the serving cell associated with the apparatus. In step S715 receiving, at the apparatus from an apparatus associated with a neighboring cell, a second information set including information associated with the neighboring cell and an MBS session provided in the neighboring cell. In step S720 determining, by the apparatus, at least one MBS serving characteristic associated with the serving cell associated with the apparatus based on the UEs in the serving cell being served by the apparatus and the received second information set. In step S725 determining, by the apparatus, whether the serving cell associated with the apparatus is a preferred cell to serve the MBS session to UEs based on the at least one MBS serving characteristic. In step S730 in response to determining that the serving cell associated with the apparatus is the preferred cell to serve the MBS session to UEs, serving, by the apparatus, the MBS session to the UEs communicatively coupled with the apparatus.

Example 2. The method of Example 1, wherein the first information set can include, for each neighboring cell providing the MBS session, a number of UEs that can be HO/DC to/with the apparatus associated with the neighboring cell from the serving cell.

Example 3. The method of Example 1, wherein the second information set can include for each serving cell associated with the apparatus providing the MBS session, a number of UEs that can be HO/DC from/with the apparatus associated with the neighboring cell.

Example 4. The method of Example 2, wherein the UE that can be HO/DC to/with the apparatus associated with the neighboring cell are the UEs for which the apparatus received, from the UE, a measurement result of the neighboring cell providing the MBS session above a threshold.

Example 5. The method of Example 2 can further include, in response to determining the apparatus should serve the MBS session to UEs communicatively coupled with the apparatus associated with the neighboring cell, and while the apparatus is serving the MBS session to the UEs that are or were communicatively coupled with the apparatus associated with the neighboring cell, causing, by the apparatus, the MBS session to be served by the apparatus as a PTM transmission.

Example 6. The method of Example 1 to Example 5 can further include, in response to determining the preferred cell to serve the MBS session to UEs is the serving cell associated with the apparatus, communicating, by the apparatus to the apparatus associated with the neighboring cell, an indication of ongoing or possible PTM transmission.

Example 7. The method of Example 1 to Example 6 can further include receiving, at the apparatus from the apparatus associated with the neighboring cell, an indication of ongoing or possible PTM transmission and causing, at the apparatus in response to the reception of the indication, an initialization of a DC/HO for the UEs communicatively coupled with the apparatus.

Example 8. The method of Example 1 to Example 3, wherein the first information set can further include a number of UEs being served the MBS session per a serving cell of the apparatus and a PTM threshold for the serving cell and the second information set can further include a number of UEs being served the MBS session per a neighboring cell of the apparatus associated with the neighboring cell and a PTM threshold for the neighboring cell.

Example 9. The method of Example 8 can further include determining, by the apparatus, at least one MBS characteristic associated with the neighboring cell based on the communicated first information set and the received second information set, determining, by the apparatus, which cell of the apparatus or the apparatus associated with the neighboring cell is the preferred cell to serve the MBS session to UEs based on the determined MBS serving characteristics, and one of serving, by the apparatus, the MBS session to the UEs communicatively coupled with the apparatus or causing, by the apparatus, an initialization of a DC/HO for the UEs coupled with the apparatus.

Example 10. The method of Example 1 to Example 9 can further include, if, for the serving cell, the apparatus is serving the MBS session as a point-to-point (PTP) transmission, and the apparatus is serving the MBS session to the UEs that are or were communicatively coupled with the apparatus associated with the neighboring cell, causing, by the apparatus, the MBS session to be served by the apparatus as a PTM transmission in the serving cell.

Example 11. The method of Example 7 to Example 10 can further include, in response to determining the neighboring cell is the preferred cell to serve the MBS session to UEs communicatively coupled with the apparatus, causing, by the apparatus, the initialization of the DC/HO for the UEs communicatively coupled with the apparatus, the DC/HO being directed to the apparatus associated with the neighboring cell.

Example 12. The method of Example 1 to Example 11, wherein the at least one MBS serving characteristic can be a UE total calculated as a sum of UEs configured to receive the MBS session and UEs that could be configured to receive that MBS session and the determining of whether a cell can be the preferred cell to serve the MBS session is based on the UE total.

Example 13. The method of Example 12, wherein determining whether a cell is the preferred cell to serve the MBS session to UEs communicatively coupled with the apparatus associated with the neighboring cell can include determining that calculated UE total will meet the PTM threshold.

Example 14. The method of Example 1 to Example 13, wherein determining whether a cell is the preferred cell to serve the MBS session to UEs communicatively coupled with the apparatus associated with the neighboring cell can be based on another criterion if two or more cells be selected based on the at least one MBS serving characteristic.

Example 15. The method of Example 14, wherein the another criterion can include at least one of a cell identification number, a number of UEs currently being served the MBS session by the apparatus, a number of UEs currently being served the MBS session by the apparatus associated with the neighboring cell, a priority of the apparatus, and a priority of the apparatus associated with the neighboring cell.

Example 16. The method of Example 1 to Example 15 can further include, if the apparatus determines that the MBS session is to be served by the apparatus associated with the neighboring cell and if the apparatus determines that the UE can be HO/DC to/with the apparatus associated with the neighboring cell, initiating a DC/HO operation directed to the apparatus associated with the neighboring cell in response to a UE being served by the apparatus joining the MBS session.

Example 17. The method of Example 1 to Example 16, wherein the communicating of the information associated with MBS session can be triggered based on Channel State Information Reference Signal (CSI-RS) measurements, the apparatus switching to PTM, the at least one apparatus associated with the neighboring cell switching to PTM, a number of UEs served by PTP changing by a predetermined number of UEs, and a UE is added to the MBS session via a DC or HO.

Example 18. The method of Example 1 to Example 17, wherein the information associated with the MBS session can be received using an Xn configuration update message or Xn setup message via an Xn interface.

Example 19. The method of Example 1 to Example 18, wherein the information associated with the MBS session can include an indication that no UEs can be configured to receive the MBS session from the apparatus.

Example 20. The method of Example 1 to Example 19 can further include triggering a DC/HO operation directed to the least one apparatus associated with the neighboring cell in response to a UE being served by the apparatus joining the MBS session.

Example 21. A non-transitory computer-readable storage medium comprising instructions stored thereon that, when executed by at least one processor, are configured to cause a computing system to perform the method of any of Examples 1-20.

Example 22. An apparatus comprising means for performing the method of any of Examples 1-20.

Example 23. An apparatus comprising at least one processor and at least one memory including computer program code, the at least one memory and the computer program code configured to, with the at least one processor, cause the apparatus at least to perform the method of any of Examples 1-20.

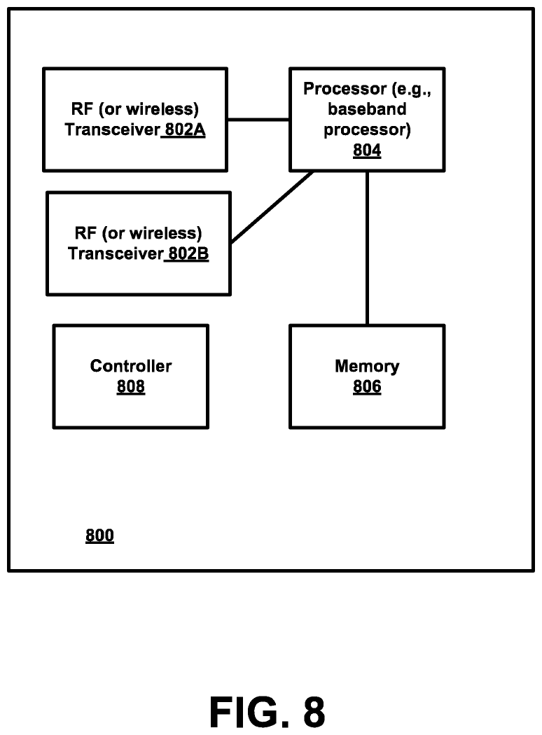

FIG. 8 is a block diagram of a wireless station 800 or wireless node or network node 800 according to an example embodiment. The wireless node or wireless station or network node 800 may include, e.g., one or more of an AP, BS, gNB, RAN node, relay node, UE or user device, network node, network entity, DU, CU-CP, CU-UP, . . . or other node) according to an example embodiment.

The wireless station 800 may include, for example, one or more (e.g., two as shown in FIG. 8) radio frequency (RF) or wireless transceivers 802A, 802B, where each wireless transceiver includes a transmitter to transmit signals and a receiver to receive signals. The wireless station also includes a processor or control unit/entity (controller) 804 to execute instructions or software and control transmission and receptions of signals, and a memory 806 to store data and/or instructions. Processor 804 may also make decisions or determinations, generate

frames, packets or messages for transmission, decode received frames or messages for further processing, and other tasks or functions described herein. Processor 804, which may be a baseband processor, for example, may generate messages, packets, frames or other signals for transmission via wireless transceiver 802 (802A or 802B). Processor 804 may control transmission of signals or messages over a wireless network, and may control the reception of signals or messages, etc., via a wireless network (e.g., after being down-converted by wireless transceiver 802, for example). Processor 804 may be programmable and capable of executing software or other instructions stored in memory or on other computer media to perform the various tasks and functions described above, such as one or more of the tasks or methods described above. Processor 804 may be (or may include), for example, hardware, programmable logic, a programmable processor that executes software or firmware, and/or any combination of these. Using other terminology, processor 804 and transceiver 802 together may be considered as a wireless transmitter/receiver system, for example.

In addition, referring to FIG. 8, a controller (or processor) 808 may execute software and instructions, and may provide overall control for the station 800, and may provide control for other systems not shown in FIG. 8, such as controlling input/output devices (e.g., display, keypad), and/or may execute software for one or more applications that may be provided on wireless station 800, such as, for example, an email program, audio/video applications, a word processor, a Voice over IP application, or other application or software.

In addition, a storage medium may be provided that includes stored instructions, which when executed by a controller or processor may result in the processor 804, or other controller or processor, performing one or more of the functions or tasks described above.

According to another example embodiment, RF or wireless transceiver(s) 802A/802B may receive signals or data and/or transmit or send signals or data. Processor 804 (and possibly transceivers 802A/802B) may control the RF or wireless transceiver 802A or 802B to receive, send, broadcast or transmit signals or data.

The example embodiments are not, however, restricted to the system that is given as an example, but a person skilled in the art may apply the solution to other communication systems. Another example of a suitable communications system is the 5G system. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Example embodiments of the various techniques described herein may be implemented in digital electronic circuitry, or in computer hardware, firmware, software, or in combinations of them. Example embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, example embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Example embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-80. (canceled)

81. An apparatus comprising:
at least one processor; and
at least one memory including computer program code,
the at least one memory and the computer program code configured to, with the at least one processor, causing the apparatus to:
identifying a multicast and broadcast services (MBS) session associated with one or more user equipment devices (UEs) in a serving cell associated with the apparatus;
communicating a first information set including information associated with the serving cell associated with the apparatus and the MBS session provided in the serving cell associated with the apparatus;
receiving, at the apparatus from an apparatus associated with a neighboring cell, a second information set including information associated with the neighboring cell and an MBS session provided in the neighboring cell;
determining, by the apparatus, at least one MBS serving characteristic associated with the serving cell associated with the apparatus based on the UEs in the serving cell being served by the apparatus and the received second information set;
determining, by the apparatus, whether the serving cell associated with the apparatus is a preferred cell to serve the MBS session to UEs based on the at least one MBS serving characteristic; and
in response to determining that the serving cell associated with the apparatus is the preferred cell to serve the MBS session to UEs:
serving, by the apparatus, the MBS session to the UEs communicatively coupled with the apparatus.

82. The apparatus of claim 81, wherein the first information set includes, for each neighboring cell providing the MBS session, a number of UEs that can be handed over/dual connected (HO/DC) to/with the apparatus associated with the neighboring cell from the serving cell.

83. The apparatus of claim 82, wherein the UE that can be HO/DC to/with the apparatus associated with the neighboring cell are the UEs for which the apparatus received, from the UE, a measurement result of the neighboring cell providing the MBS session above a threshold.

84. The apparatus of claim 82, the at least one processor, further causing the apparatus to:
in response to determining the apparatus should serve the MBS session to UEs communicatively coupled with the apparatus associated with the neighboring cell, and while the apparatus is serving the MBS session to the UEs that are or were communicatively coupled with the apparatus associated with the neighboring cell, causing, by the apparatus, the MBS session to be served by the apparatus as a point-to-multipoint (PTM) transmission.

85. The apparatus of claim 81, wherein the second information set includes for each serving cell associated with the apparatus providing the MBS session, a number of UEs that can be HO/DC from/with the apparatus associated with the neighboring cell.

86. The apparatus of claim 81, the at least one processor, further causing the apparatus to:
in response to determining the preferred cell to serve the MBS session to UEs is the serving cell associated with the apparatus, communicating, by the apparatus to the apparatus associated with the neighboring cell, an indication of ongoing or possible PTM transmission.

87. The apparatus of claim 81, the at least one processor, further causing the apparatus to:
receiving, at the apparatus from the apparatus associated with the neighboring cell, an indication of ongoing or possible PTM transmission; and
causing, at the apparatus in response to the reception of the indication, an initialization of a DC/HO for the UEs communicatively coupled with the apparatus.

88. The apparatus of claim 87, the at least one processor, further causing the apparatus to:
in response to determining the neighboring cell is the preferred cell to serve the MBS session to UEs communicatively coupled with the apparatus, causing, by the apparatus, the initialization of the DC/HO for the UEs communicatively coupled with the apparatus, the DC/HO being directed to the apparatus associated with the neighboring cell.

89. The apparatus of claim 81, wherein
the first information set further includes a number of UEs being served the MBS session per a serving cell of the apparatus and a PTM threshold for the serving cell, and
the second information set further includes a number of UEs being served the MBS session per a neighboring cell of the apparatus associated with the neighboring cell and a PTM threshold for the neighboring cell.

90. The apparatus of claim 89, the at least one processor, further causing the apparatus to:
determining, by the apparatus, at least one MBS characteristic associated with the neighboring cell based on the communicated first information set and the received second information set;
determining, by the apparatus, which cell of the apparatus or the apparatus associated with the neighboring cell is the preferred cell to serve the MBS session to UEs based on the determined MBS serving characteristics; and
one of:
serving, by the apparatus, the MBS session to the UEs communicatively coupled with the apparatus, or
causing, by the apparatus, an initialization of a DC/HO for the UEs coupled with the apparatus.

91. The apparatus of claim 81, the at least one processor, further causing the apparatus to:
if, for the serving cell, the apparatus is serving the MBS session as a point-to-point (PTP) transmission, and the apparatus is serving the MBS session to the UEs that are or were communicatively coupled with the apparatus associated with the neighboring cell, causing, by the apparatus, the MBS session to be served by the apparatus as a PTM transmission in the serving cell.

92. The apparatus of claim 81, wherein
the at least one MBS serving characteristic is a UE total calculated as a sum of UEs configured to receive the MBS session and UEs that could be configured to receive that MBS session, and
the determining of whether a cell is the preferred cell to serve the MBS session is based on the UE total.

93. The apparatus of claim 92, wherein determining whether a cell is the preferred cell to serve the MBS session to UEs communicatively coupled with the apparatus associated with the neighboring cell includes determining that calculated UE total will meet the PTM threshold.

94. The apparatus of claim 81, wherein determining whether a cell is the preferred cell to serve the MBS session to UEs communicatively coupled with the apparatus associated with the neighboring cell is based on another criterion if two or more cells be selected based on the at least one MBS serving characteristic.

95. The apparatus of claim 94, wherein the another criterion includes at least one of a cell identification number, a number of UEs currently being served the MBS session by the apparatus, a number of UEs currently being served the MBS session by the apparatus associated with the neighboring cell, a priority of the apparatus, or a priority of the apparatus associated with the neighboring cell.

96. The apparatus of claim 81, further comprising:
if the apparatus determines that the MBS session is to be served by the apparatus associated with the neighboring cell and if the apparatus determines that the UE can be HO/DC to/with the apparatus associated with the neighboring cell, initiating a DC/HO operation directed to the apparatus associated with the neighboring cell in response to a UE being served by the apparatus joining the MBS session.

97. The apparatus of claim 81, wherein the communicating of the information associated with MBS session is triggered based on Channel State Information Reference Signal (CSI-RS) measurements, the apparatus switching to PTM, the at least one apparatus associated with the neighboring cell switching to PTM, a number of UEs served by PTP changing by a predetermined number of UEs, and a UE is added to the MBS session via a DC or HO.

98. The apparatus of claim 81, wherein the information associated with the MBS session is received using an Xn configuration update message or Xn setup message via an Xn interface, or wherein the information associated with the MBS session includes an indication that no UEs can be configured to receive the MBS session from the apparatus.

99. The apparatus of claim 81, the at least one processor, further causing the apparatus to trigger a DC/HO operation directed to the least one apparatus associated with the neighboring cell in response to a UE being served by the apparatus joining the MBS session.

100. A method comprising:
identifying a multicast and broadcast services (MBS) session associated with one or more user equipment devices (UEs) in a serving cell associated with an apparatus;
communicating a first information set including information associated with the serving cell associated with the apparatus and the MBS session provided in the serving cell associated with the apparatus;
receiving, at the apparatus from an apparatus associated with a neighboring cell, a second information set including information associated with the neighboring cell and an MBS session provided in the neighboring cell;
determining, by the apparatus, at least one MBS serving characteristic associated with the serving cell associated with the apparatus based on the UEs in the serving cell being served by the apparatus and the received second information set;
determining, by the apparatus, whether the serving cell associated with the apparatus is a preferred cell to serve the MBS session to UEs based on the at least one MBS serving characteristic; and
in response to determining that the serving cell associated with the apparatus is the preferred cell to serve the MBS session to UEs:
serving, by the apparatus, the MBS session to the UEs communicatively coupled with the apparatus.
